(19) United States
(12) Patent Application Publication
(10) Pub. No.: US 2025/0035843 A1
(43) Pub. Date: Jan. 30, 2025

(54) DETECTION DEVICE USING OPTICAL FIBER

(71) Applicant: Robert D. Morgan, Parma, ID (US)

(72) Inventor: Robert D. Morgan, Parma, ID (US)

(73) Assignee: Lite Industries, Inc., Parma, ID (US)

(21) Appl. No.: 18/715,837

(22) PCT Filed: Aug. 28, 2023
(86) PCT No.: PCT/US2023/031256

§ 371 Date: Jun. 3, 2024

Related U.S. Application Data
(60) Provisional application No. 63/378,398, filed on Oct. 5, 2022.
(60) Provisional application No. 63/489,374, filed on Mar. 9, 2023.

(51) Int. Cl. G02B 6/125; G02B 6/12; H04B 10/85

(52) U.S. Cl. CPC G02B 6/125; G02B 6/12007; H04B 10/85; G02B 2006/12119; G02B 2006/12138; G02B 2006/1215; G02B 2006/12192

(57) ABSTRACT

Devices, systems, and methods for a detection device using optical fiber are described herein. In some examples, one or more embodiments include a detection device comprising a splitter, where the splitter is to be connected to a feed leg of an optical fiber, and the splitter is to split the feed leg of the optical fiber into a destination leg and a detection leg, where the detection leg is oriented in a loop, and an actuation mechanism, where when the actuation mechanism is in an engaged orientation, the actuation mechanism is to cause a microbend in the detection leg, and when the actuation mechanism is in a disengaged orientation, the actuation mechanism is to cause the microbend to be removed from the detection leg.

### TECHNICAL FIELD

The present disclosure relates to devices, systems, and methods for a detection device using optical fiber.

### BACKGROUND

Optical fibers can be utilized to transmit information. An optical fiber can be comprised of a number of glass fibers surrounded by a cladding layer. Information, such as data, can be transmitted on an optical fiber via light pulses from a light source, which cause photons to reflect off the glass fibers and the cladding layer as they transit through the optical fiber. Such light pulses can be encoded in a way to transmit information through the optical fiber.

### BRIEF DESCRIPTION OF THE DRAWINGS

FIG. 1 is an example of a detection device using optical fiber in accordance with one or more embodiments of the present disclosure.

FIG. 2 is an example of a system including a detection device using optical fiber, a light source, a sensor, and a controller in accordance with one or more embodiments of the present disclosure.

FIG. 3A is an example of an actuation mechanism in an engaged orientation, the actuation mechanism including an actuator and a clamp in accordance with one or more embodiments of the present disclosure.

FIG. 3B is an example of an actuation mechanism including the actuator and the clamp in a disengaged orientation in accordance with one or more embodiments of the present disclosure.

FIG. 4A is an example of an actuation mechanism in an engaged orientation, the actuation mechanism including an actuator and a clamp, and a spring located around a portion of a detection leg in accordance with one or more embodiments of the present disclosure.

FIG. 4B is an example of an actuation mechanism including the actuator and the clamp in a disengaged orientation in accordance with one or more embodiments of the present disclosure.

FIG. 5A is an example of an actuation mechanism in an engaged orientation, the actuation mechanism including a linearly translatable rod in a short position in accordance with one or more embodiments of the present disclosure.

FIG. 5B is an example of an actuation mechanism in a disengaged orientation including the linearly translatable rod in a long position in accordance with one or more embodiments of the present disclosure.

FIG. 6A is an example of an actuation mechanism in an engaged orientation, the actuation mechanism including a hinge rotatable about a pin in a rotated position in accordance with one or more embodiments of the present disclosure.

FIG. 6B is an example of an actuation mechanism in a disengaged orientation including the hinge and the pin in non-rotated position in accordance with one or more embodiments of the present disclosure.

FIG. 7A is an example of an actuation mechanism in an engaged orientation, the actuation mechanism including an actuator, a clamp, and a moisture activated plug in accordance with one or more embodiments of the present disclosure.

FIG. 7B is an example of an actuation mechanism including the actuator and the clamp in a disengaged orientation in accordance with one or more embodiments of the present disclosure.

FIG. 8 is an example of a detection device using optical fiber and a trigger in accordance with one or more embodiments of the present disclosure.

FIG. 9 is an example of a system including a housing having an access point and a trigger in accordance with one or more embodiments of the present disclosure.

FIG. 10 is an example of a system including a plurality of splitters and a plurality of filters in accordance with one or more embodiments of the present disclosure.

FIG. 11 is an example of a detection device using optical fiber having reflective particles in accordance with one or more embodiments of the present disclosure.

FIG. 12 is an example of a detection device using optical fiber having reflective particles in accordance with one or more embodiments of the present disclosure.

FIG. 13 is an example of a controller for a detection device using optical fiber in accordance with one or more embodiments of the present disclosure.

### DETAILED DESCRIPTION

As mentioned above, optical fibers can be utilized to transmit information using light. Light may be generated by a light source in such a way as to encode information, such as data, for transmission through the optical fibers. Utilizing optical fibers for transmission of data can have certain advantages, such as higher bandwidth and faster transmission speeds, as compared with utilizing conductive cabling for such transmission. Accordingly, optical fibers can be useful for long-distance and/or high-performance data networking, as well as in telecommunication services such as Internet, television, and telephone lines, among other uses.

In an optical fiber transmission system, various points in the transmission system may be provided at which a user may access the optical fiber transmission system. Such points can be, for instance, housings in which a user may access the optical fiber transmission system. For example, a housing may be a point at which different links of optical fibers are linked (e.g., spliced) together, a point at which the optical fiber light signal is regenerated (e.g., via repeater(s)), splitting of optical fibers into sub-networks for distribution to individual areas (e.g., homes, businesses, etc.), distributing optical fibers to cellular or other communication cabinets, and/or may be a point at which maintenance may be performed on the optical fiber transmission system, among other examples. The housing may be accessed (e.g., by a user) via an access point of the housing.

Many such housings may exist in an optical fiber transmission system. However, monitoring of these housings is not typically performed. As a result, it is difficult to determine whether a particular housing was accessed and, if such access occurred, when such a housing was accessed.

Because monitoring is not typically performed, uncontrolled access to such housings can occur, and as a result, there may be uncontrolled access to the optical fiber transmission system itself. With this vulnerability, a nefarious user may be able to access an optical fiber transmission system via a housing in order to steal data and/or disrupt transmissions. Further, maintenance workers and/or fiber optic technicians may access the wrong housing by mistake or through curiosity. Such unauthorized and/or accidental intrusions can cause considerable fiscal and or financial damage. For example, a nefarious user may be able to steal valuable data from the optical fiber transmission system. As another example, a user (nefarious or otherwise) may cause damage to the optical fiber transmission system (e.g., upon exiting of the housing), such as by breaking a fiber, and/or damage the housing itself.

Additionally, in some examples certain housings may be located in areas where water may be a concern. For example, water seeping into the housing may cause damage to the housing and/or the optical fiber transmission system itself.

Accordingly, a detection device using optical fiber can allow for a passive, real-time monitoring of a housing included in an optical fiber transmission system. A microbend can be created in a particular portion of the optical fiber, and when the microbend is removed, an event can be determined to have happened. Such an event may include a user accessing a housing and/or water entering the housing. The detection device using optical fiber can provide for water detection, as well as better access detection to a housing, as compared with previous approaches. Accordingly, such an approach can discourage nefarious intrusions into housings, reduce incidences of accidental intrusions into housings causing damage, and prevent water from causing significant damage inside of housings. Further, the detection device using optical fiber can add a level of security to the optical fiber networks for such network providers, making it more difficult to steal data from the optical fiber transmission system, as compared with previous approaches.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

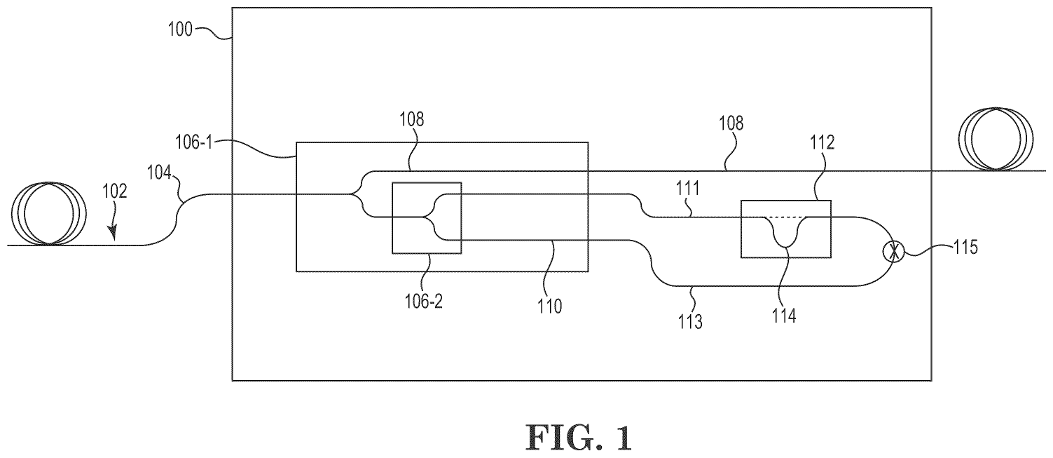

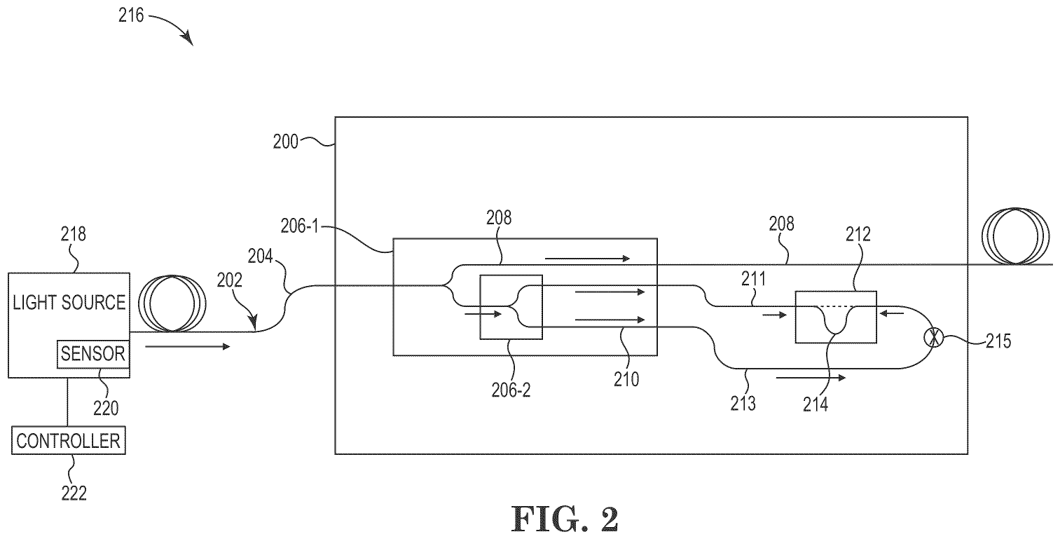

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 is an example of a detection device 100 using optical fiber in accordance with one or more embodiments of the present disclosure. The detection device 100 can include a first splitter 106-1 and an actuation mechanism 112.

As mentioned above, the detection device 100 may be included in an optical fiber transmission system. The optical fiber transmission system can include an optical fiber 102. For example, the optical fiber transmission system may be transmitting data via light pulses generated by a light source (e.g., not illustrated in FIG. 1) through the optical fiber 102.

Although not illustrated in FIG. 1, the detection device 100 can be included in a housing associated with the optical fiber transmission system. The housing may be the point at which a user may access and/or interact with the optical fiber transmission system. For example, the housing may be a point at which different links of optical fibers are linked (e.g., spliced) together, a point at which the optical fiber light signal is regenerated (e.g., via repeater(s)), splitting of optical fibers into sub-networks for distribution to individual areas (e.g., homes, businesses, etc.), distributing optical fibers to cellular or other communication cabinets, and/or may be a point at which maintenance may be performed on the optical fiber transmission system, among other examples.

The optical fiber transmission system can include the optical fiber 102 to transmit information. The optical fiber 102 can be a traveling fiber, which may extend a long distance (e.g., as indicated in FIG. 1 by the looped fiber symbol) between multiple structures and/or housings to be monitored. The optical fiber 102 can include a plurality of splice locations along the optical fiber 102, such as at housings for detection.

The optical fiber 102 can include a feed leg 104. As used herein, the feed leg 104 can be, for example, the portion of the optical fiber 102 that enters the housing and the detection device 100. Additionally, the optical fiber 102 can include a destination leg 108. As used herein, the destination leg 108 can be, for example, the portion of the optical fiber 102 that exits the housing and the detection device 100. The destination leg 108 can also extend a long distance (e.g., as indicated in FIG. 1 by the looped fiber symbol) between multiple structures and/or housings to be monitored). When information is transmitted on the optical fiber 102, light can travel (e.g., propagate) through the optical fiber 102 and the feed leg 104 into the detection device 100, and a portion of the light can travel through the destination leg 108 and out of the detection device 100, as is further described herein.

In order to provide a detection mechanism for when the housing is accessed, the housing can include the detection device 100. As used herein, the detection device 100 can be a device that provides a measurable response to a change in a physical condition. For example, the detection device 100 can allow a sensor to detect light in certain circumstances, as is further described herein.

In order to provide such detection, the detection device 100 can include a first splitter 106-1. As used herein, a splitter can be a device that divides one input into two or more outputs. The first splitter 106-1 can be connected to the feed leg 104 of the optical fiber 102. The first splitter 106-1 can split the feed leg 104 input of the optical fiber 102 into the destination leg 108 and a detection leg 110.

For example, the first splitter 106-1 can split the optical fiber 102 in order to split light traveling through the optical fiber 102. For instance, the first splitter 106-1 can split the feed leg 104 into the destination leg 108 and the detection leg 110 such that 98% of the light emitted from a light source travels down the destination leg 108 and 2% of the light travels down the detection leg 110. The detection device 100 can utilize the 2% of the light in order to detect intrusion into the housing, as is further described herein.

In some examples, the first splitter 106-1 can be a fused biconical splitter (FBT) splitter. For example, the FBT splitter can include fibers twisted and fused together while being elongated and tapered. In this example, the FBT splitter can split the feed leg 104 into the destination leg 108 and the detection leg 110.

In some examples, the first splitter 106-1 can be a planar lightwave circuit (PLC) splitter. For example, the PLC splitter can include aligned waveguide circuits included in a printed circuit board (PCB). In this example, the PLC splitter can split the feed leg 104 into the destination leg 108 and the detection leg 110.

Although the first splitter 106-1 is described above as being an FBT or a PLC splitter, embodiments of the present disclosure are not so limited. For example, the first splitter 106-1 can be any variation of an FBT splitter or a PLC splitter, and/or any other type of splitter.

As illustrated in FIG. 1, the detection leg 110 is oriented in a loop. For example, the detection leg 110 is oriented such that the optical fiber comprising the detection leg forms a closed curve within itself.

In order to create the loop of the detection leg 110, the detection device 100 can include a second splitter 106-2. The second splitter 106-2 can split the detection leg 110 into a first section 111 and a second section 113. As mentioned above, the first splitter 106-1 can split the feed leg 104 such that 2% of the light travels down the detection leg 110. The second splitter 106-2 can further split the 2% of the light traveling down the detection leg 110, as is further described in connection with FIG. 2. The first section 111 and the second section 113 can be spliced together at the splice location 115 in order to form the loop. In other words, the detection leg 110 can include the first section 111 and the second section 113 and can be spliced back onto itself to form the loop. The first section 111 and the second section 113 can be manufactured to include the loop. The second splitter 106-2 can be an FBT splitter, PLC splitter, any variation thereof, and/or any other type of splitter.

Although the splice location 115 is illustrated in FIG. 1 as being located to the right (e.g., as oriented in FIG. 1) of the actuation mechanism 112, embodiments of the present disclosure are not so limited. For example, the splice location 115 can be located anywhere on the detection leg 110.

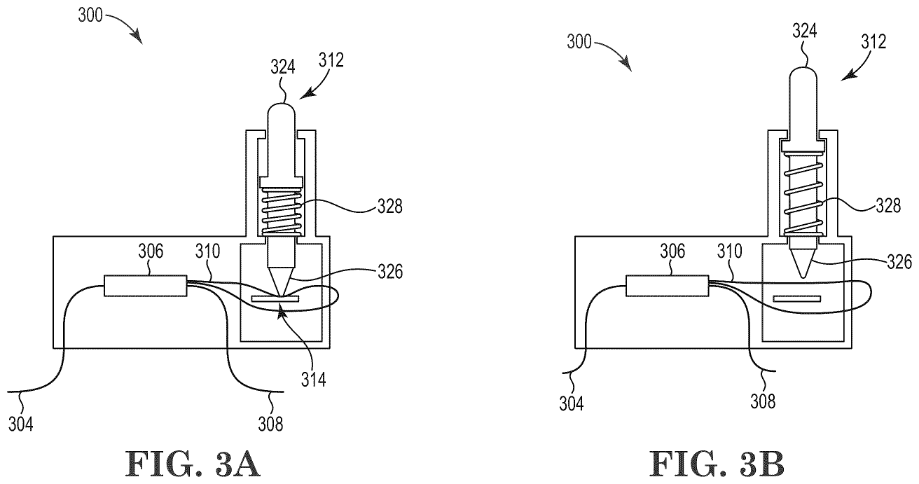

The detection device 100 can further include an actuation mechanism 112. As used herein, the actuation mechanism 112 can be a device that acts upon an environment by converting stored energy into motion. The actuation mechanism 112 can be a number of different mechanisms, as is further described in connection with FIGS. 3-7.

The actuation mechanism 112 can act upon the detection leg 110 to cause a microbend 114 in the detection leg 110. For example, when the actuation mechanism is in an engaged orientation, the actuation mechanism 112 can cause the microbend 114 in the detection leg 110. The microbend 114 in the detection leg 110 can be a bend in the optical fiber comprising the detection leg 110 that restricts light travel down the fiber beyond the bend. The actuation mechanism 112 can be biased towards the engaged orientation such that the actuation mechanism 112 is normally in the engaged orientation.

When the actuation mechanism 112 is in the disengaged orientation, the actuation mechanism 112 can cause the microbend 114 to be removed from the detection leg 110. A controller can determine when the microbend 114 is removed from the detection leg 110, as is further described herein.

FIG. 2 is an example of a system 216 including a detection device 200 using optical fiber 202, a light source 218, a sensor 220, and a controller 222 in accordance with one or more embodiments of the present disclosure. The detection device 200 can include a first splitter 206-1, a second splitter 206-2, and an actuation mechanism 212.

As previously described in connection with FIG. 1, the detection device 200 can include a first splitter 206-1, a second splitter 206-2, and an actuation mechanism 212. The first splitter 206-1 can be connected to the feed leg 204 of an optical fiber 202 and can split the feed leg 204 into a destination leg 208 and a detection leg 210.

The system 216 can include a light source 218. As used herein, the light source 218 can be a device that generates light. The light source 218 can be, for example, a light emitting diode (LED), a laser, a laser diode, and/or any other semiconductor-based light source.

The system 216 can additionally include a sensor 220. As used herein, the sensor 220 can be a device to detect events and/or changes in its environment and transmit the detected events and/or changes for processing and/or analysis. For example, the sensor 220 can be a device that detects reflection of light waves in an optical fiber transmission system. The sensor 220 can be, for example, a reflectometer, such as an optical time-domain reflectometer, among other types of sensors. Accordingly, the sensor 220 can detect light that is reflected through the loop of the detection leg 210, and the controller 222 can determine whether the actuation mechanism is in the disengaged orientation (e.g., and accordingly, whether a housing was accessed or water has entered the housing) based on whether the sensor 220 detects light, as is further described herein.

The light source 218 can generate light in the form of light waves. The light waves can be generated by the light source 218 and can propagate through the feed leg 204. As illustrated in FIG. 2, the splitter 206-1 can split the feed leg 204 into a destination leg 208 and a detection leg 210 oriented in a loop. Accordingly, the splitter 206-1 can cause a first portion of light waves to be propagated through the destination leg 208 and a second portion of light waves to be propagated through the detection leg 210. For example, the splitter 206-1 can cause 98% of light waves generated by the light source 218 to be propagated through the destination leg 208, and 2% of light waves generated by the light source 218 to be propagated through the detection leg 210.

As previously described in connection with FIG. 1, the detection device 200 can include the actuation mechanism 212. When the actuation mechanism 212 is in the engaged orientation (e.g., as illustrated in FIG. 2), the actuation mechanism 212 can cause the microbend 214 in the loop of the detection leg 210. The microbend 214 can cause the 2% of the light waves propagated into the detection leg 210 to be attenuated in the loop.

For example, the second splitter 206-2 can split the detection leg 210 into a first section 211 and a second section 213, where the first section 211 and the second section 213 are spliced back onto each other at the splice location 215. Of the 2% of the light waves propagated into the detection leg 210, 1% of the light waves can be propagated into the first section 211 and 1% of the light waves can be propagated into the second section 213 (e.g., as indicated by the arrows illustrated in FIG. 2). However, because the microbend 214 is present in the loop of the detection leg 210, the microbend 214 attenuates the light waves in the loop. Due to the attenuation of the light waves in the loop of the detection leg 210, the sensor 220 is unable to detect any reflection of light waves from the loop of the detection leg 210. That is, there is not sufficient reflectivity that can be detected by the sensor 220 due to the presence of the microbend 214. In response to the sensor 220 not detecting the reflectivity of light waves from the loop of the detection leg 210, the controller 222 can determine that the actuation mechanism 212 is in the engaged orientation. As a result of the determination that the actuation mechanism 212 is in the engaged orientation, the controller 222 can determine that access to the housing has not occurred, or that water has not entered the housing.

When the actuation mechanism 212 is in a disengaged orientation, the actuation mechanism 212 can cause the microbend 214 to be removed from the loop of the detection leg 210. Continuing with the example from above, when the microbend 214 is removed from the loop of the detection leg 210, light waves can transit through the loop of the detection leg 210. Because the detection leg is oriented in a loop, those light waves transiting through the loop can be propagated back towards the light source 218.

For example, when the actuation mechanism 212 is in the disengaged orientation and the microbend 214 is not present in the detection leg 210, the 2% of the light waves propagated into the detection leg 210 (e.g., the 1% into the first section 211 and the 1% into the second section 213) can be propagated around the loop and back to the feed leg 204 causing the second portion of the light waves to be propagated back towards the light source 218.

As mentioned above, the sensor 220 can detect the light waves propagated back towards the light source 218. For example, the sensor 220 can detect a reflectivity of the light waves transiting around the loop of the detection leg 210. In response to the reflectivity exceeding a threshold value, the sensor 220 can transmit a signal to the controller 222. Such a scenario can be referred to as a reflective event.

The controller 222 can receive the signal from the sensor 220 in response to the sensor 220 detecting the light waves propagated back towards the light source 218. In response to receiving the signal, the controller 222 can determine the actuation mechanism 212 is in the disengaged orientation. As a result of the reflective event and the determination that the actuation mechanism 212 is in the disengaged orientation, the controller 222 can determine that access to the housing has occurred, or that water has entered the housing.

Although the controller 222 is illustrated in FIG. 2 as being remote from the detection device 200, embodiments of the present disclosure are not so limited. For example, the controller 222 can attached to the detection device 200, located within (e.g., included in) the detection device 200, be a part of the light source 218, among other examples.

As mentioned above, the detection leg 210 can be oriented in a loop. The loop configuration of the detection leg 210 can provide a higher reflectivity signal when the microbend 214 is not present in the detection leg 210, as compared to previous approaches not utilizing a loop, such as a detection leg having a reflective material at the end of the detection leg.

In response to determining the actuation mechanism 212 is in the disengaged orientation (e.g., and that the housing has been accessed or water has entered the housing), the controller 222 can generate an alert. Additionally, the controller 222 can transmit the alert. Such an alert can be transmitted to, for example, a central monitoring station (e.g., a remote computing device, not illustrated in FIG. 2), a mobile device of a user (e.g., not illustrated in FIG. 2), and/or to any other device. Such an alert can notify a user of the reflective event detected by the sensor 220. Additionally, the controller 222 can log the date and/or time the reflective event was detected by the sensor 220, and/or an identifier of the detection device 200 associated with the reflective event. The controller 222 can compile such information and generate a report detailing the reflective event, and such a report may be transmitted to the remote computing device, mobile device, etc.

The actuation mechanism 212 as described above can be in an engaged position to create the microbend 214 in the detection leg 210 or a disengaged position to remove the microbend 214 from the detection leg 210. The actuation mechanism 212 can include a number of different mechanisms to create and/or remove the microbend 214, as is further described in connection with FIGS. 3-7.

FIG. 3A is an example of an actuation mechanism 312 in an engaged orientation, the actuation mechanism 312 including an actuator 324 and a clamp 326 in accordance with one or more embodiments of the present disclosure. The actuation mechanism 312 can be included in a detection device 300.

As previously described in connection with FIGS. 1 and 2, the detection device 300 can include a feed leg 304 and a splitter 306 to split the feed leg 304 into a destination leg 308 and a detection leg 310. The detection leg 310 can be oriented in a loop.

The actuation mechanism 312 can include an actuator 324 and a clamp 326. As used herein, the actuator 324 can be a device that causes another device to operate. As used herein, the clamp 326 can be a device that secures an object in a particular orientation. The spring 328 can include a spring seat with an opposing spring seat positioned on the frame of the actuator 1024.

As illustrated in FIG. 3A, the actuation mechanism 312 can be in the engaged orientation. The actuator 324 can be caused to linearly translate (e.g., in a downward direction, as oriented in FIG. 3A) to an engaged position to cause the clamp 326 to directly contact the detection leg 310 to cause the microbend 314 in the detection leg 310. For example, the clamp 326 can bend or compress the optical fiber of the detection leg 310 against a bend plate, forming the microbend 314. When the actuator 324 is in the engaged position, the actuation mechanism 312 can be in the engaged orientation to cause the microbend 314 to attenuate light waves in the loop of the detection leg 310.

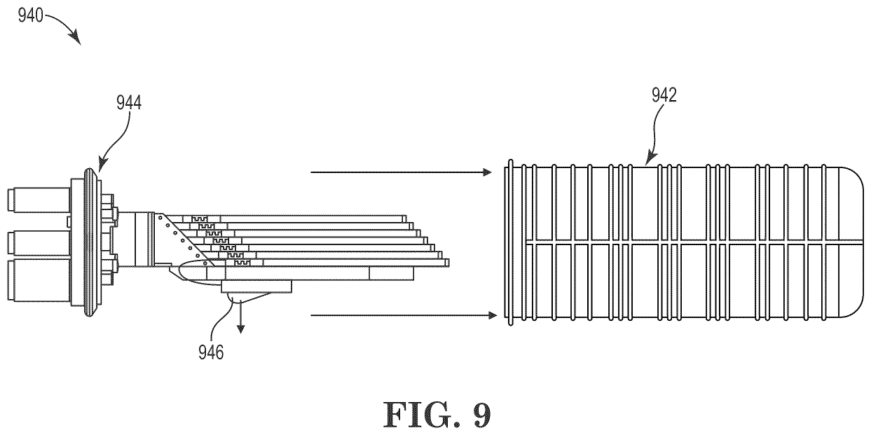

Although not illustrated in FIG. 3A, a trigger can cause the actuation mechanism 312 (e.g., and the actuator 324) to linearly translate such that the actuation mechanism 312 is in the engaged orientation. The trigger can cause the actuation mechanism 312 to be biased towards the engaged orientation and can compress the spring 328 located around the actuator 324. The trigger can be included in a housing, as is further described in connection with FIG. 9.

FIG. 3B is an example of an actuation mechanism 312 including the actuator 324 and the clamp 326 in a disengaged orientation in accordance with one or more embodiments of the present disclosure. The actuation mechanism 312 can be included in the detection device 300.

As previously described in connection with FIGS. 1 and 2, the detection device 300 can include a feed leg 304 and a splitter 306 to split the feed leg 304 into a destination leg 308 and a detection leg 310. The detection leg 310 can be oriented in a loop.

As illustrated in FIG. 3B, the actuation mechanism 312 can be in the disengaged orientation. For example, the spring 328 can decompress, causing the actuation mechanism to move from the engaged orientation to the disengaged orientation, and the clamp 326 linearly translates from the engaged position to a disengaged position away from the detection leg 310. When the clamp 326 moves away from the detection leg 310, the microbend is removed from the detection leg 310, and light waves can transit through the loop of the detection leg 310 to be detected by a sensor. The actuation mechanism 312 can move to the disengaged orientation in response to a housing being accessed.

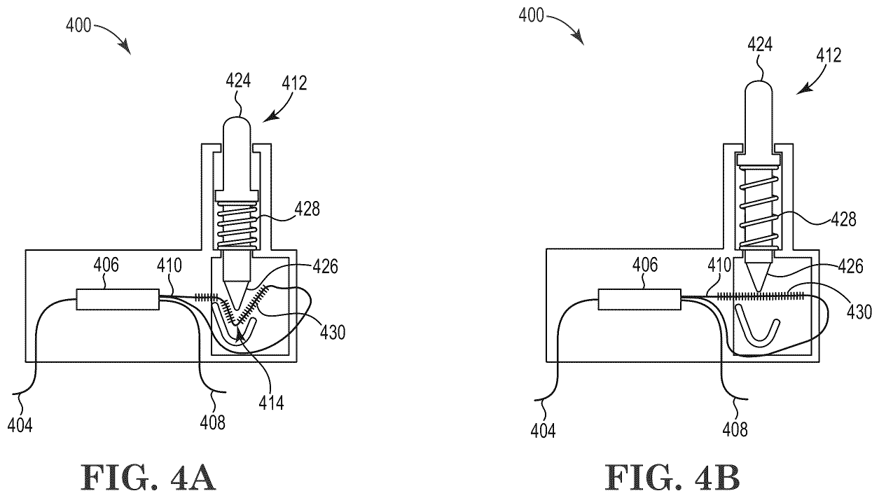

FIG. 4A is an example of an actuation mechanism 412 in an engaged orientation, the actuation mechanism 412 including an actuator 424 and a clamp 426, and a spring 430 located around a portion of a detection leg 410 in accordance with one or more embodiments of the present disclosure. The actuation mechanism 412 can be included in a detection device 400.

Similar to the detection device previously described in connection with FIGS. 3A and 3B, the detection device 400 can include a feed leg 404 and a splitter 406 to split the feed leg 404 into a destination leg 408 and a detection leg 410. The detection leg 410 can be oriented in a loop and can include the spring 430 located around a portion of the detection leg 410.

As illustrated in FIG. 4A, the actuation mechanism 412 can be in the engaged orientation. The actuator 424 can be caused to linearly translate (e.g., in a downward direction, as oriented in FIG. 4A) to an engaged position to cause the clamp 426 to directly contact the portion of the detection leg 410 having the spring 430 to cause the spring 430 to be in a deformed position to cause the microbend 414 in the detection leg 410. When the actuator 424 is in the engaged position, the actuation mechanism 412 can be in the engaged orientation to cause the microbend 414 to attenuate light waves in the loop of the detection leg 410. Similar to the example previously described in connection with FIG. 3A, a trigger can cause the actuation mechanism 412 (e.g., and the actuator 424) to linearly translate such that the actuation mechanism 412 is in the engaged orientation.

FIG. 4B is an example of an actuation mechanism 412 including the actuator 424 and the clamp 426 in a disengaged orientation in accordance with one or more embodiments of the present disclosure. The actuation mechanism 412 can be included in the detection device 400.

As previously described in connection with FIGS. 1 and 2, the detection device 400 can include a feed leg 404 and a splitter 406 to split the feed leg 404 into a destination leg 408 and a detection leg 410. The detection leg 410 can be oriented in a loop.

As illustrated in FIG. 4B, the actuation mechanism 412 can be in the disengaged orientation. For example, the spring 428 can decompress, causing the actuation mechanism 412 to move from the engaged orientation to the disengaged orientation, and the clamp 426 linearly translates from the engaged position to a disengaged position away from the detection leg 410. When the clamp 426 moves away from the detection leg 410, the spring 430 causes the microbend to be removed from the detection leg 410 as the spring 430 reverts back from the deformed position to a normal position, and light waves can transit through the loop of the detection leg 410 to be detected by a sensor. The actuation mechanism 412 can move to the disengaged orientation in response to a housing being accessed.

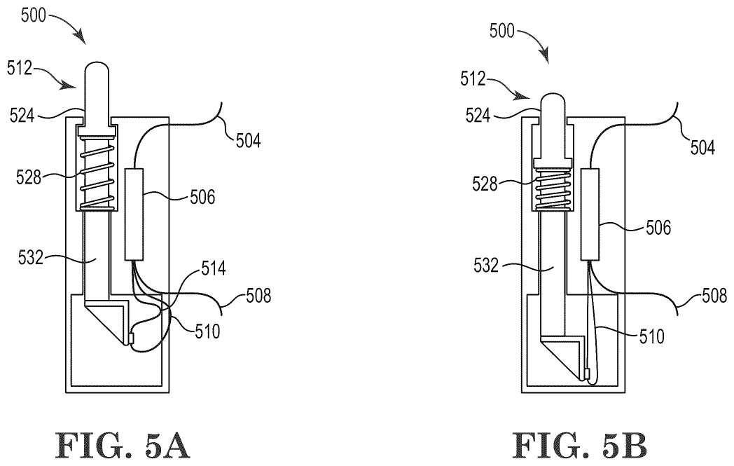

FIG. 5A is an example of an actuation mechanism 512 in an engaged orientation, the actuation mechanism 512 including a linearly translatable rod 532 in a short position in accordance with one or more embodiments of the present disclosure. The actuation mechanism 512 can be included in a detection device 500.

As previously described in connection with FIGS. 1 and 2, the detection device 500 can include a feed leg 504 and a splitter 506 to split the feed leg 504 into a destination leg 508 and a detection leg 510. The detection leg 510 can be oriented in a loop.

The actuation mechanism 512 can include a linearly translatable rod 532. The linearly translatable rod 532 can be connected to an actuator 524. The actuator 524 can be caused to linearly translate (e.g., in an upward direction, as oriented in FIG. 5A) to an engaged position to cause the linearly translatable rod 532 to be in a short position. When the linearly translatable rod 532 is in the short position, an amount of slack in the detection leg 510 can cause the microbend 514 in the detection leg 510. When the actuator 524 is in the engaged position, the actuation mechanism 512 can be in the engaged orientation to cause the microbend 514 to attenuate light waves in the loop of the detection leg 510.

FIG. 5B is an example of an actuation mechanism 512 in a disengaged orientation including the linearly translatable rod 532 in a long position in accordance with one or more embodiments of the present disclosure. The actuation mechanism 512 can be included in the detection device 500.

As previously described in connection with FIGS. 1 and 2, the detection device 500 can include a feed leg 504 and a splitter 506 to split the feed leg 504 into a destination leg 508 and a detection leg 510. The detection leg 510 can be oriented in a loop.

As illustrated in FIG. 5B, the actuation mechanism 512 can be in the disengaged orientation. For example, the spring 528 can be compressed, causing the actuation mechanism 512 to move from the engaged orientation to the disengaged orientation, and the linearly translatable rod 532 linearly translates from the short position to a long position to cause the microbend to be removed from the detection leg 510. For example, the translation of the linearly translatable rod 532 to the long position removes the slack from the detection leg 510, removing the microbend 514 from the detection leg 510. Light waves can accordingly transit through the loop of the detection leg 510 to be detected by a sensor. The actuation mechanism 512 can move to the disengaged orientation in response to a housing being accessed.

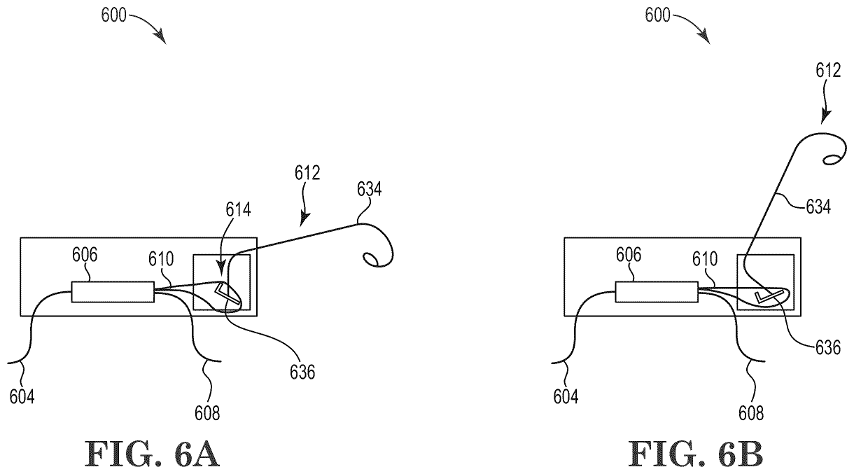

FIG. 6A is an example of an actuation mechanism 612 in an engaged orientation, the actuation mechanism 612 including a hinge 634 rotatable about a pin 636 in a rotated position in accordance with one or more embodiments of the present disclosure. The actuation mechanism 612 can be included in a detection device 600.

As previously described in connection with FIGS. 1 and 2, the detection device 600 can include a feed leg 604 and a splitter 606 to split the feed leg 604 into a destination leg 608 and a detection leg 610. The detection leg 610 can be oriented in a loop.

As illustrated in FIG. 6A, the actuation mechanism 612 can be in the engaged orientation. The hinge 634 can be rotated about the pin 636 (e.g., in a clockwise direction, as oriented in FIG. 6A) to a rotated position to cause the pin 636 to cause the microbend 614 in the detection leg 610. For example, a flange located on the pin 636 can directly contact a portion of the detection leg 610 to cause the microbend 614 as a result of the hinge 634 rotating the pin 636.

Although not illustrated in FIG. 6A, a trigger can cause the actuation mechanism 612 (e.g., and the hinge 634 and pin 636) to rotate such that the actuation mechanism 612 is in the engaged orientation. The trigger can cause the actuation mechanism 612 to be biased towards the engaged orientation. The trigger can be included in a housing, as is further described in connection with FIG. 9.

FIG. 6B is an example of an actuation mechanism 612 in a disengaged orientation including the hinge 634 and the pin 636 in non-rotated position in accordance with one or more embodiments of the present disclosure. The actuation mechanism 612 can be included in the detection device 600.

As previously described in connection with FIGS. 1 and 2, the detection device 600 can include a feed leg 604 and a splitter 606 to split the feed leg 604 into a destination leg 608 and a detection leg 610. The detection leg 610 can be oriented in a loop.

As illustrated in FIG. 6B, the actuation mechanism 612 can be in the disengaged orientation. For example, the hinge 634 can rotate about the pin 636 (e.g., in a counterclockwise direction, as oriented in FIG. 6B) from the rotated position to a non-rotated position to cause the microbend to be removed from the detection leg. When the flange rotates away from the detection leg 610, the microbend is removed from the detection leg 610, and light waves can transit through the loop of the detection leg 610 to be detected by a sensor. The actuation mechanism 612 can move to the disengaged orientation in response to a housing being accessed.

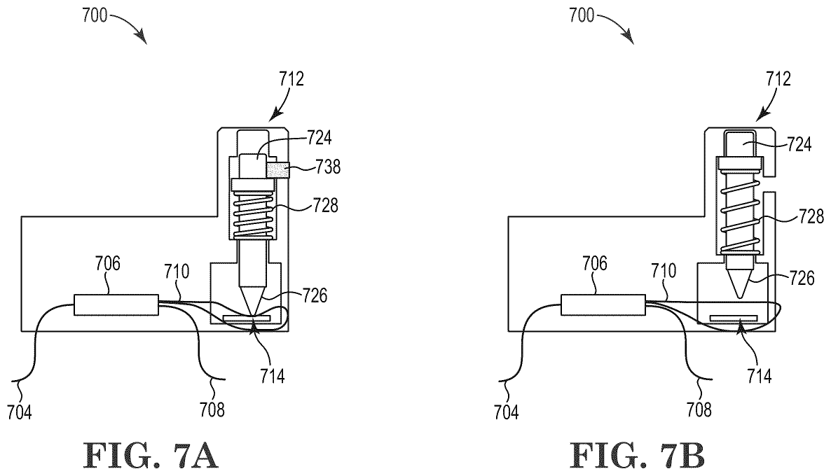

FIG. 7A is an example of an actuation mechanism in an engaged orientation, the actuation mechanism including an actuator 724, a clamp 726, and a moisture activated plug 738 in accordance with one or more embodiments of the present disclosure. The actuation mechanism 712 can be included in a detection device 700.

As previously described in connection with FIGS. 1 and 2, the detection device 700 can include a feed leg 704 and a splitter 706 to split the feed leg 704 into a destination leg 708 and a detection leg 710. The detection leg 710 can be oriented in a loop.

As illustrated in FIG. 7A, the actuation mechanism 712 can be in the engaged orientation. The actuator 724 can be caused to linearly translate (e.g., in a downward direction, as oriented in FIG. 7A) to an engaged position to cause the clamp 726 to directly contact the detection leg 710 to cause the microbend 714 in the detection leg 710. When the actuator 724 is in the engaged position, the actuation mechanism 712 can be in the engaged orientation to cause the microbend 714 to attenuate light waves in the loop of the detection leg 710.

As illustrated in FIG. 7A, the detection device 700 can include a moisture activated plug 738. As used herein, the moisture activated plug 738 can be a device made of a material that degrades upon exposure to moisture. The moisture activated plug 738 can cause the actuation mechanism 712 (e.g., and the actuator 724) to linearly translate such that the actuation mechanism 712 is in the engaged orientation. The moisture activated plug 738 can cause the actuation mechanism moisture activated plug 738 to be biased towards the engaged orientation and can compress the spring 728 located around the actuator 724.

FIG. 7B is an example of an actuation mechanism 712 including the actuator 724 and the clamp 726 in a disengaged orientation in accordance with one or more embodiments of the present disclosure. The actuation mechanism 712 can be included in the detection device 700.

As previously described in connection with FIGS. 1 and 2, the detection device 700 can include a feed leg 704 and a splitter 706 to split the feed leg 704 into a destination leg 708 and a detection leg 710. The detection leg 710 can be oriented in a loop.

As illustrated in FIG. 7B, the actuation mechanism 712 can be in the disengaged orientation. For example, in response to moisture interacting with the moisture activated plug, the moisture activated plug can deteriorate, causing the actuation mechanism 712 to move from the engaged orientation to the disengaged orientation, and the clamp 726 to linearly translate from the engaged position to a disengaged position away from the detection leg 710. When the clamp 726 moves away from the detection leg 710, the microbend is removed from the detection leg 310, and light waves can transit through the loop of the detection leg 710 to be detected by a sensor. Accordingly, the actuation mechanism 712 can move to the disengaged position in response to water entering the housing.

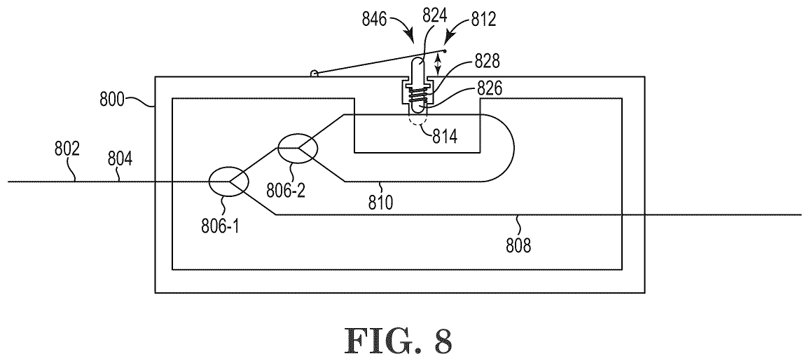

FIG. 8 is an example of a detection device 800 using optical fiber 802 and a trigger 846 in accordance with one or more embodiments of the present disclosure. The detection device 800 can include a first splitter 806-1, a second splitter 806-2, an actuation mechanism 812, and a trigger 846.

The first splitter 806-1 can split the feed leg 804 input of the optical fiber 802 into the destination leg 808 and a detection leg 810. The second splitter 806-2 can split the detection leg 810 in order for the detection leg 810 to be oriented in a loop.

The detection device 800 can include a trigger 846. The trigger 846 can be a device that releases a spring or catch in order to set off a mechanism. For example, as previously described above with respect to FIGS. 3-6, the trigger 846 can bias the actuation mechanism 812 (e.g., including the actuator 824, the clamp 826, and the spring 828) to an engaged orientation. As such, while a housing is not accessed by a user, the actuation mechanism 812 remains in the engaged orientation, and as such, the microbend 814 is located in the detection leg 810.

However, as illustrated in FIG. 8, when a housing is accessed (e.g., removed), the trigger 846 can actuate (e.g., release upwards, as oriented in FIG. 8), causing the spring 828 to decompress causing the actuation mechanism 812 to move from the engaged orientation to a disengaged orientation. As described above, when the actuation mechanism 812 is in the disengaged orientation, the microbend 814 is removed, allowing a sensor to detect light waves reflected through the detection leg 810. As such, a controller can determine the actuation mechanism 812 is in the disengaged orientation and as such, that the housing was accessed.

FIG. 9 is an example of a system 940 including a housing 942 having an access point 944 and a trigger 946 in accordance with one or more embodiments of the present disclosure. The housing 942 can house a detection device, as previously described above.

As previously described above, the housing 942 may be the point at which a user may access and/or interact with the optical fiber transmission system. For example, the housing 942 may be a point at which different links of optical fibers are linked (e.g., spliced) together, a point at which the optical fiber light signal is regenerated (e.g., via repeater(s)), splitting of optical fibers into sub-networks for distribution to individual areas (e.g., homes, businesses, etc.), distributing optical fibers to cellular or other communication cabinets, and/or may be a point at which maintenance may be performed on the optical fiber transmission system, and can include a fiber optic enclosure such as an ILA or light signal regeneration hut, among other examples. The housing 942 can include an access point 944 and a trigger 946, as is further described herein.

As illustrated in FIG. 9, the housing 942 can include an enclosure dome or shell that can be removed via the access point 944. For example, the housing 942 can slide away from the access point 944, exposing the optical fiber transmission system located within. The optical fiber transmission system may include optical fibers that are normally enclosed by the housing 942 and may be routed through various cassettes also enclosed by the housing 942.

The detection device can include a trigger 946. The trigger 946 can be a device that releases a spring or catch in order to set off a mechanism. For example, as previously described above with respect to FIGS. 3-6, the trigger 946 can bias the actuation mechanism to an engaged orientation while the housing 942 is installed and connected (e.g., not accessed) and covering the optical fiber transmission system located therein. As such, while the housing 942 is not accessed by a user, the actuation mechanism remains in the engaged orientation, and as such, the microbend is located in the detection leg.

However, as illustrated in FIG. 9, when the housing 942 is accessed (e.g., removed), the trigger 946 can actuate (e.g., release downwards, as oriented in FIG. 9), allowing the actuation mechanism to move from the engaged orientation to a disengaged orientation. As described above, when the actuation mechanism is in the disengaged orientation, the microbend is removed, allowing a sensor to detect light waves reflected through the detection leg. As such, a controller can determine the actuation mechanism is in the disengaged orientation and as such, that the housing 942 was accessed.

Although the housing 942 is illustrated and described as an enclosure/cover/lid/shell, embodiments of the present disclosure are not so limited. For example, the housing 942 may always cover the optical fiber transmission system and the access point 944 may be a door such that when the door is opened, the trigger 946 is actuated to cause the microbend to be removed from the detection leg.

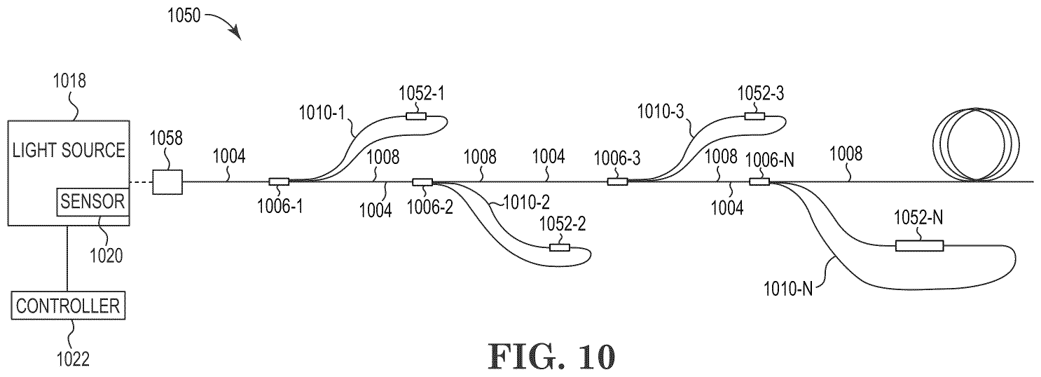

FIG. 10 is an example of a system 1050 including a plurality of splitters 1006 and a plurality of filters 1052 in accordance with one or more embodiments of the present disclosure. Each of the plurality of splitters 1006 can include a corresponding detection leg 1010.

As illustrated in FIG. 10, the system 1050 can be an optical fiber transmission system including a plurality of splitters 1006-1, 1006-2, 1006-3, 1006-N (referred to collectively as plurality of splitters 1006). Each of the plurality of splitters 1006 can include a corresponding detection leg 1010-1, 1010-2, 1010-3, 1010-N (referred to collectively as plurality of detection legs 1010) and a corresponding and unique filter 1052-1, 1052-2, 1052-3, 1052-N (referred to collectively as plurality of filters 1052). For example, the splitter 1006-1 can include a detection leg 1010-1 having an associated filter 1052-1, splitter 1006-2 can include a detection leg 1010-2 having an associated filter 1052-2, splitter 1006-3 can include a detection leg 1010-3 having an associated filter 1052-3, and splitter 1006-N can include a detection leg 1010-N having an associated filter 1052-N.

As illustrated in FIG. 10, a light source 1018 can generate light waves for transmission on the system 1050. Each of the splitters 1006 can be associated with a corresponding housing (e.g., as previously described in connection with FIG. 9) such that access monitoring of each of the housings can be performed.

In order to allow the controller to determine which housing is accessed, each splitter 1006 can include an associated filter 1052. As used herein, the filter 1052 can be a device that selectively passes a particular wavelength. For example, filter 1052-1 can be a filter that only allows light waves in the wavelength of 1,550 nanometers (nm), filter 1052-2 can be a filter that only allows light waves in the wavelength of 1,570 nm, filter 1052-3 can be a filter that only allows light waves in the wavelength of 1,590 nm, and filter 1052-N can be a filter that only allows light waves in the wavelength of 1,610 nm. Accordingly, only the particular wavelength associated with the particular filter 1052 can be propagated back towards the light source 1018 and sensor. The filter can be, for instance, a coarse wavelength division multiplexing (CWDM) filter, among other types of filters.

For example, if a housing associated with the splitter 1006-1 is accessed, the microbend in the detection leg 1010-1 can be removed (e.g., as previously described above) allowing light waves to be reflected back towards the light source 1018 and a sensor. However, the filter 1052-1 can filter out all but light waves in the 1,270 nm wavelength, allowing only those light waves in the 1,270 nm wavelength to be reflected back to the sensor. As such, the controller can determine, based on the wavelength detected by the sensor, the particular housing associated with the particular splitter 1006-1 that was accessed. For example, the controller can include a predetermined lookup table in memory that associates particular wavelengths with particular housings. Therefore, if the controller detects light of a particular wavelength (e.g., 1,550 nm), the controller can compare the reading to the lookup table and determine, based on the reading of 1,550 nm, that the wavelength is associated with a housing having splitter 1006-1. Accordingly, the filters 1052 can allow for the controller to differentiate between housings, allowing for monitoring of a plurality of housing in the optical fiber transmission system and detection when a single or a plurality of housings are accessed.

While the depicted examples above utilize wavelengths between 1,550-1,610 nm, embodiments of the present disclosure are not so limited. For example, wavelengths less than 1,550 nm may be utilized, as well as wavelengths above 1,610 nm may be utilized. Accordingly, while the depicted examples above utilize the infrared (IR) light spectrum, embodiments of the present disclosure are not so limited. For example, any light spectrum may be utilized, including other wavelengths in IR, ultraviolet (UV) spectrum, visible spectrum, etc.

As illustrated in FIG. 10, the system 1050 can include an in-line filter 1058. The in-line filter 1058 can be a filter that can allow certain wavelengths through the filter. The in-line filter 1058 can be, for example, a passive in-line spectrum filter. The in-line filter 1058 can allow predefined/specified wavelengths through the in-line filter 1058. For example, the in-line filter 1058 can allow wavelengths of 1,550 nm (e.g., associated with filter 1052-1), 1,570 nm (e.g., associated with filter 1052-2), 1,590 nm (e.g., associated with filter 1052-3), and 1,610 nm (e.g., associated with filter 1052-N). Such wavelengths can be propagated to the light source 1018, sensor 1020, and for analysis by the controller 1022.

The in-line filter 1058 can be included as part of the light source 1018, connected to the light source 1018, or can be a standalone filter located upstream of the light source 1018. Such possibilities are indicated in FIG. 10 via the dashed line between the in-line filter 1058 and the light source 1018.

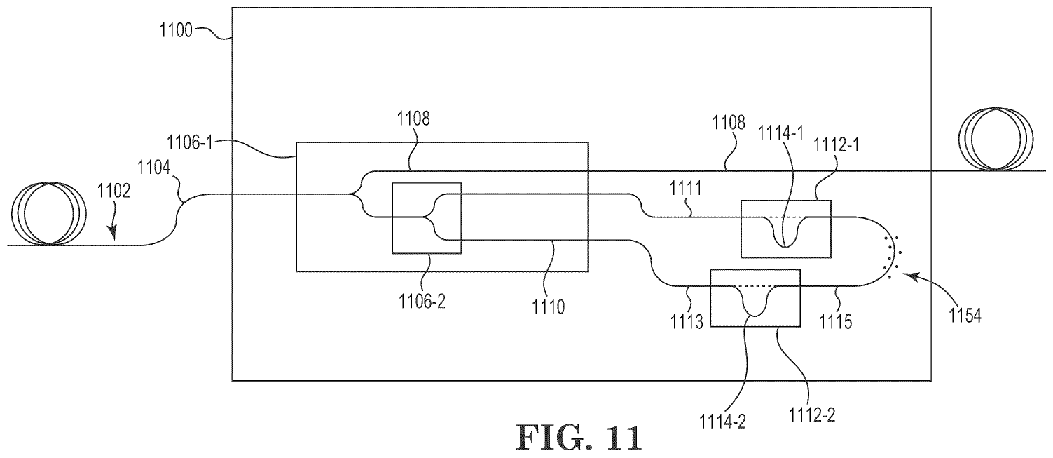

FIG. 11 is an example of a detection device 1100 using optical fiber having reflective particles 1154 in accordance with one or more embodiments of the present disclosure. The detection device 1100 can include a first splitter 1106-1, a second splitter 1106-2, a first actuation mechanism 1112-1, and a second actuation mechanism 1112-2.

Similar to the detection device of FIG. 1, the detection device 1100 can be included in an optical fiber transmission system including an optical fiber 1102 having a feed leg 1104. The feed leg 1104 can be split into a destination leg 1108 and a detection leg 1110 by the first splitter 1106-1. The detection leg 1110 can be split into the first section 1111 and the second section 1113 by the second splitter 1106-2.

In some examples, the detection leg 1110 can include reflective particles 1154 as illustrated in FIG. 11. The reflective particles 1154 can be particles included in the optical fiber 1102 of the detection leg 1110 to increase reflectivity in the optical fiber 1102. For example, the reflective particles 1154 can be silver nitrate nanoparticles in a core of the optical fiber. The reflective particles 1154 can help to regain dynamic range loss in the optical fiber 1102 that occurs as a result of the first splitter 1106-1 and second splitter 1106-2 splitting the optical fiber 1102. For example, the first splitter 1106-1 and the second splitter 1106-2 can introduce a dynamic range loss (e.g., a loss in distance the light waves can propagate from a pulse of the light source) in the optical fiber, and the reflective particles 1154 can increase the dynamic range of the light waves to make up for the dynamic range loss caused by the first splitter 1106-1 and the second splitter 1106-2. The reflective particles 1154 can be any number and/or size based on a particular desired reflectivity amount for the light waves for propagation back toward the sensor. Accordingly, the reflective particles 1154 can allow for the use of a splitter that splits a lower percentage (e.g., 2%, 1%, etc.) of light waves from the feed leg 1104.

While the reflective particles 1154 are illustrated in FIG. 11 as being located around the optical fiber 1102, such reflective particles 1154 are merely shown as being around the optical fiber 1102 for ease of illustration. Rather, as mentioned above, the reflective particles 1154 are located in the core of the optical fiber 1102.

The detection device 1100 can include the first actuation mechanism 1112-1 and a second actuation mechanism 1112-2. The first actuation mechanism 1112-1 and second actuation mechanism 1112-2 can be the same type of actuation mechanism or different types of actuation mechanisms (e.g., as previously described in connection with FIGS. 3-7).

The reflective particles 1154 can be located between the first actuation mechanism 1112-1 and the second actuation mechanism 1112-2. When the first actuation mechanism 1112-1 and the second actuation mechanism 1112-2 are in the engaged orientation, the first actuation mechanism 1112-1 can cause a first microbend 1114-1 and the second actuation mechanism 1112-2 can cause a second microbend 1114-2. The first microbend 1114-1 and the second microbend 1114-2 can attenuate light waves in the detection leg 1110 and prevent such light waves from interacting with the reflective particles 1154.

When the first actuation mechanism 1112-1 and the second actuation mechanism 1112-2 are in the disengaged orientation, the first microbend 1114-1 and the second microbend 1114-2 can be removed from the loop of the detection leg 1110. Accordingly, light waves can transit through the loop of the detection leg 1110. The reflective particles 1154 can increase reflectivity of the light waves as they transit through the loop and propagate back towards the light source and sensor for detection.

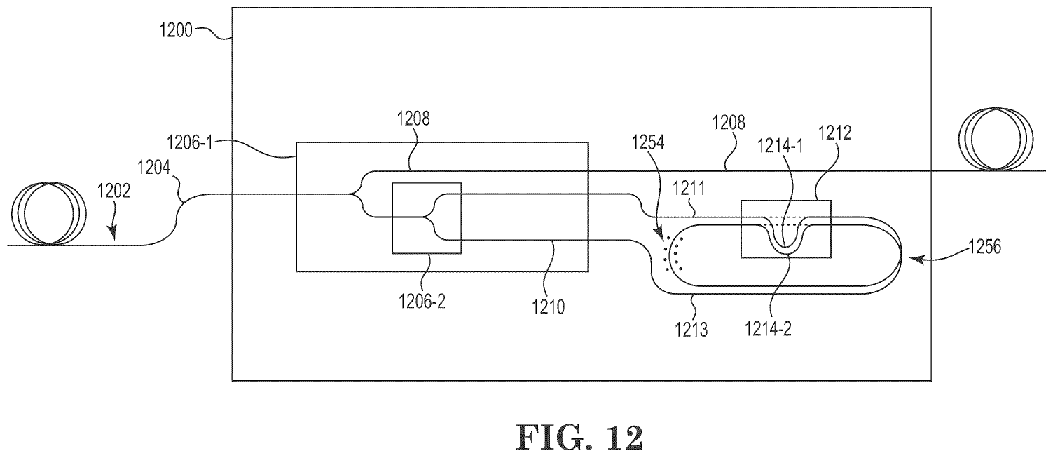

FIG. 12 is an example of a detection device 1200 using optical fiber having reflective particles 1254 in accordance with one or more embodiments of the present disclosure. The detection device 1200 can include a first splitter 1206-1, a second splitter 1206-2, and actuation mechanism 1212.

Similar to the detection device of FIG. 1, the detection device 1200 can be included in an optical fiber transmission system including an optical fiber 1202 having a feed leg 1204. The feed leg 1204 can be split into a destination leg 1208 and a detection leg 1210 by the first splitter 1206-1. The detection leg 1210 can be split into the first section 1211 and the second section 1213 by the second splitter 1206-2.

In some examples, the detection leg 1210 can include reflective particles 1254 as illustrated in FIG. 12. Similar to FIG. 11, the reflective particles 1254 can be particles included in the optical fiber of the detection leg 1210 to increase reflectivity in the optical fiber 1202. The reflective particles 1254 can help to regain dynamic range loss in the optical fiber 1202 that occurs as a result of the first splitter 1206-1 and second splitter 1206-2 splitting the optical fiber 1202. The reflective particles 1254 can be any number and/or size based on a particular desired reflectivity amount for the light waves for propagation back toward the sensor.

While the reflective particles 1254 are illustrated in FIG. 12 as being located around the optical fiber 1202, such reflective particles 1254 are merely shown as being around the optical fiber 1202 for ease of illustration. Rather, as mentioned above, the reflective particles 1254 are located in the core of the optical fiber 1202.

The detection device 1200 can include actuation mechanism 1212. The actuation mechanism 1212 can be any of the actuation mechanisms as previously described in connection with FIGS. 3-7.

The detection leg 1210 can be looped through the actuation mechanism 1212 twice. Accordingly, the actuation mechanism 1212 can cause a first microbend 1214-1 a second microbend 1214-2 when the actuation mechanism 1212 is in the engaged orientation. The reflective particles 1254 can be located between the first microbend 1214-1 and the second microbend 1214-2. The first microbend 1214-1 and the second microbend 1214-2 can attenuate light waves in the detection leg 1210 and prevent such light waves from interacting with the reflective particles 1254.

When the actuation mechanism 1212 is in the disengaged orientation, the first microbend 1214-1 and the second microbend 1214-2 can be removed from the loop of the detection leg 1210. Accordingly, light waves can transit through the loop of the detection leg 1210. The reflective particles 1254 can increase reflectivity of the light waves as they transit through the loop and propagate back towards the light source and sensor for detection.

A detection device using optical fiber can allow for passive, real-time monitoring of an optical fiber transmission system including a plurality of housings. Utilizing a microbend in a loop-oriented detection leg can allow for better reflectivity detection by a sensor, as compared with previous approaches utilizing a non-loop detection leg having a reflective material at one end. As such, the detection device can provide for better housing access detection as well as water entering the housing as compared with previous approaches. Accordingly, such an approach can discourage nefarious intrusions into housings, reduce incidences of accidental intrusions into housings causing damage, and prevent water from causing significant damage inside of housings. Further, the detection device using optical fiber can add a level of security to the optical fiber networks for such network providers, making it more difficult to steal data from the optical fiber transmission system, as compared with previous approaches.

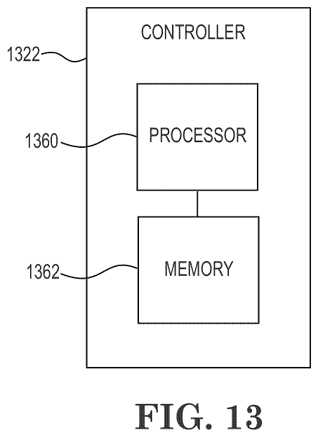

FIG. 13 is an example of a controller 1322 for a detection device using optical fiber in accordance with one or more embodiments of the present disclosure. As illustrated in FIG. 13, the controller 1322 can include a memory 1362 and a processor 1360 for a detection device using optical fiber, in accordance with the present disclosure.

The memory 1362 can be any type of storage medium that can be accessed by the processor 1360 to perform various examples of the present disclosure. For example, the memory 1362 can be a non-transitory computer readable medium having computer readable instructions (e.g., executable instructions/computer program instructions) stored thereon that are executable by the processor 1360 for a detection device using optical fiber in accordance with the present disclosure.

The memory 1362 can be volatile or nonvolatile memory. The memory 1362 can also be removable (e.g., portable) memory, or non-removable (e.g., internal) memory. For example, the memory 1362 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 1362 is illustrated as being located within controller 1322, embodiments of the present disclosure are not so limited. For example, memory 1362 can also be located internal to another computing resource (e.g., enabling computer readable instructions to be downloaded over the Internet or another wired or wireless connection).

The processor 1360 may be a central processing unit (CPU), a semiconductor-based microprocessor, and/or other hardware devices suitable for retrieval and execution of machine-readable instructions stored in the memory 1362.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A detection device, comprising:
a splitter, wherein:
the splitter is configured to be connected to a feed leg of an optical fiber; and
the splitter is configured to split the feed leg of the optical fiber into a destination leg and a detection leg, wherein the detection leg is oriented in a loop;
an actuation mechanism, wherein:
when the actuation mechanism is in an engaged orientation, the actuation mechanism is configured to cause a microbend in the detection leg; and
when the actuation mechanism is in a disengaged orientation, the actuation mechanism is configured to cause the microbend to be removed from the detection leg.

2. The detection device of claim 1, wherein the detection leg is spliced back onto itself to form the loop.

3. The detection device of claim 1, wherein when light waves are generated by a light source and propagate through the feed leg, the splitter causes a first portion of the light waves to be propagated through the destination leg and a second portion of the light waves to be propagated through the detection leg.

4. The detection device of claim 3, wherein when the actuation mechanism is in the engaged orientation, the microbend is configured to restrict the second portion of the light waves such that the second portion of the light waves are attenuated in the loop.

5. The detection device of claim 3, wherein when the actuation mechanism is in the disengaged orientation, the second portion of the light waves are propagated around the loop of the detection leg and back to the feed leg causing the second portion of the light waves to be propagated back towards the light source.

6. The detection device of claim 1, wherein the actuation mechanism is biased towards the engaged orientation.

7. The detection device of claim 1, wherein the actuation mechanism includes an actuator and a clamp such that:
when the actuation mechanism is in the engaged orientation, the actuator is configured to cause the clamp to linearly translate to an engaged position to directly contact the detection leg to cause the microbend in the detection leg; and
when the actuation mechanism moves from the engaged orientation to the disengaged orientation, the clamp linearly translates from the engaged position to a disengaged position to cause the microbend to be removed from the detection leg.

8. The detection device of claim 7, wherein a spring is located around a portion of the detection leg including a location at which the clamp directly contacts the detection leg such that when the actuation mechanism is in the disengaged orientation, the spring causes the microbend to be removed from the detection leg.

9. The detection device of claim 1, wherein the actuation mechanism includes a linearly translatable rod such that:
when the actuation mechanism is in the engaged orientation, the linearly translatable rod is in a short position causing the microbend in the detection leg; and
when the actuation mechanism moves from the engaged orientation to the disengaged orientation, the linearly translatable rod linearly translates from the short position to a long position to cause the microbend to be removed from the detection leg.

10. The detection device of claim 1, wherein the actuation mechanism includes a hinge rotatable about a pin such that:
when the actuation mechanism is in the engaged orientation, the hinge is in a rotated position causing the microbend in the detection leg; and
when the actuation mechanism moves from the engaged orientation to the disengaged orientation, the hinge rotates about the pin from the rotated position to a non-rotated position to cause the microbend to be removed from the detection leg.

11. The detection device of claim 1, wherein the actuation mechanism includes a moisture activated plug such that:
the actuation mechanism is biased towards the engaged orientation; and
in response to moisture interacting with the moisture activated plug, the moisture activated plug is configured to deteriorate causing the actuation mechanism to move from the engaged orientation to the disengaged orientation to cause the microbend to be removed from the detection leg.

12. A detection device, comprising:
an optical fiber including a feed leg;
a detection device including:
a splitter configured to be connected to the feed leg, wherein the splitter is configured to split the feed leg into a destination leg and a detection leg oriented in a loop such that when light waves are generated by a light source and propagated through the feed leg, the splitter causes:
a first portion of the light waves to be propagated through the destination leg; and
a second portion of the light waves to be propagated through the detection leg; and
an actuation mechanism, wherein:
when the actuation mechanism is in an engaged orientation, the actuation mechanism is configured to cause a microbend in the loop of the detection leg such that the second portion of the light waves are attenuated in the loop; and
when the actuation mechanism is in a disengaged orientation, the actuation mechanism is configured to cause the microbend to be removed from the loop of the detection leg such that the second portion of the light waves are propagated around the loop of the detection leg and back to the feed leg causing the second portion of the light waves to be propagated back towards the light source; and
a controller configured to determine when the actuation mechanism is in the disengaged orientation.

13. The detection device of claim 12, further including a different splitter configured to split the detection leg into a first section and a second section, wherein the first section and the second section are spliced together to form the loop.

14. The detection device of claim 12, wherein the controller is configured to receive a signal from a sensor in response to the sensor detecting the light waves propagated back towards the light source.

15. The detection device of claim 14, wherein the controller is configured to determine the actuation mechanism is in the disengaged orientation in response to receiving the signal.

16. The detection device of claim 12, wherein the controller is configured to transmit an alert in response to determining the actuation mechanism is in the disengaged orientation.

17. A system, comprising:
a housing including an access point and a trigger;
an optical fiber including a feed leg, wherein the optical fiber enters the housing via the feed leg;
a detection device located in the housing, the detection device including:
a splitter configured to be connected to the feed leg, wherein the splitter is configured to split the feed leg into a destination leg that exits the housing and a detection leg oriented in a loop such that when light waves are generated by a light source and propagated through the feed leg, the splitter causes:
a first portion of the light waves to be propagated through the destination leg; and
a second portion of the light waves to be propagated through the detection leg; and
an actuation mechanism, wherein:
the trigger causes the actuation mechanism to be in an engaged orientation when the access point is secured with the housing such that the actuation mechanism causes a microbend in the loop of the detection leg causing the second portion of the light waves to be attenuated in the loop; and
when the access point of the housing is accessed, the trigger causes the actuation mechanism to be in a disengaged orientation such that the actuation mechanism causes the microbend to be removed from the loop of the detection leg causing:
the second portion of the light waves to be propagated around the loop of the detection leg and back to the feed leg; and
the second portion of the light waves to be propagated back towards the light source; and
a controller configured to determine when the actuation mechanism is in the disengaged orientation.

18. The system of claim 17, wherein the splitter includes a filter such that when the actuation mechanism is in the disengaged orientation, only a particular wavelength associated with the filter of the second portion of the light waves are propagated back towards the light source.

19. The system of claim 18, wherein:
the system further includes a plurality of splitters each associated with a housing of a plurality of housings; and
each splitter of the plurality of splitters includes a different and unique filter each having a different particular wavelength associated therewith.

20. The system of claim 19, wherein the controller is configured to determine, based on a wavelength of light detected by a sensor, a particular housing associated with a particular splitter that was accessed.
